(19) United States
(12) Patent Application Publication
(10) Pub. No.: US 2025/0327197 A1
(43) Pub. Date: Oct. 23, 2025

(54) BIPOLAR PLATE AND PRODUCTION

(71) Applicant: Siemens Energy Global GmbH & Co. KG, München (DE)

(72) Inventors: Christian Reller, Minden (DE); Ralf Krause, Herzogenaurach (DE); Florian Kessler, Wachenroth (DE); Erik Wolf, Röttenbach (DE)

(21) Appl. No.: 18/868,870

(22) PCT Filed: May 18, 2023
(86) PCT No.: PCT/EP2023/063419

§ 371 Date: Nov. 25, 2024

(30) Foreign Application Priority Data
May 23, 2022 (DE) 10 2022 205 126.2

(51) Int. Cl. C25B 11/036; B32B 15/01; C25B 1/04; C25B 11/046

(52) U.S. Cl. CPC C25B 11/036; B32B 15/013; C25B 11/046; B32B 2311/22; B32B 2457/00; C25B 1/04

(57) ABSTRACT

A bipolar plate that is configured for electrolysis has a lower metal sheet and an upper metal sheet. The lower and upper metal sheets are interlinked and the materials of the metal sheets are distinctly different from each other, meaning that one of them is iron-based or nickel-based and the other is not, or an alloying element is present to a greater or lesser degree, or a proportion of an alloying element differs between the materials of the two metal sheets.

The invention relates to a bipolar plate and to production thereof.

The lifetime of PEM-based water electrolyzers is influenced to a crucial degree by the release of polyvalent transition metal ions and the associated membrane damage. The corresponding bipolar plate is of particular relevance, since this is exposed both to cathodic and anodic potentials and to hydrogen (H₂) and oxygen (O₂) reactants.

The literature discloses a multitude of technical solutions that are based primarily on PVD-based coatings: TiN, CrN, TiCN or TiC.

Conductive thin films of Au, TiN, TiN/C or TaN have been used in many cases for protection of stainless steel from corrosion. However, all these coatings fail and do not offer the necessary corrosion protection, especially at high potentials.

Application of hard layers, e.g. TiN, has the disadvantage that they are applied to very thin substrates and, because of mechanical stresses, tend to crack under bending or mechanical stress. Single-sidedly coated substrates in particular are subject to mechanical stress, which promotes detachment of the protective layer. A further disadvantage with respect to metallic contact materials is lower electrical conductivity.

Technical implementation of PVD coating is usually limited to component dimensions of less than 1.2 m in length, which limits the scalability of electrolysis cells. A further disadvantage is elevated component costs in the case of coated components.

When single-ply thin metal sheets (VA steel or Ti) are used as bipolar plate, signs of corrosion are found: Titanium (Ti), through the presence of hydrogen and cathodic potential, tends to form titanium hydride TiHₙ (n=0.5-2), which can react to give Ti₃O₅ or Ti³⁺.

Stainless steels and nickel base alloys under anodic potential (>1.5 V vs. RHE) show signs of corrosion in the region of the grain boundaries.

In the case of chromium-nickel steels, irreversible damage is found in the region of the chromium oxide passivation layer.

It is therefore an object of the invention to solve the abovementioned problem.

The object is achieved by a bipolar plate as claimed in claim 1 and a process as claimed in claim 12.

The dependent claims list further advantageous features that can be combined with one another as desired in order to achieve further benefits.

The figures show:

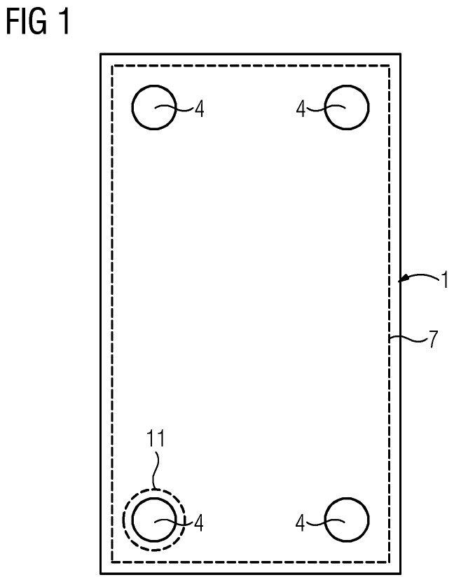

FIG. 1 a bipolar plate in top view,

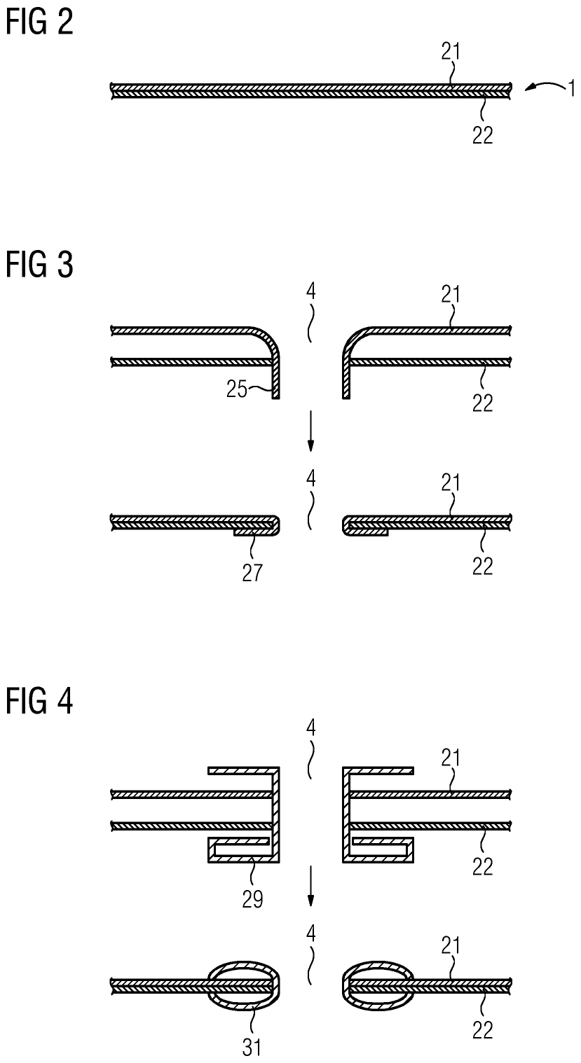

FIG. 2 a cross section through FIG. 1,

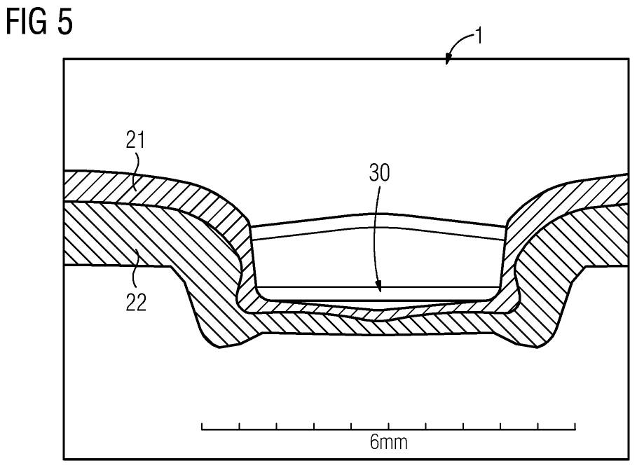

FIGS. 3, 4 seals in the region of apertures,

FIG. 5 a clinch bond.

Specifications for bipolar plates for PEM water electrolysis are
corrosion resistance at high potentials (>1.5 V versus reversible hydrogen electrode; RHE)
temperatures (T)=60° C.-80° C. (333 K-353 K)
acidic environments (pH=0 to 6) saturated with O₂
high electrical conductivity through the plane
low contact resistance and low frit voltage
inexpensive material and easy and scalable deposition methodology
resistance to hydrogen (H₂) embrittlement (cathode)
resistance to oxygen (O₂) embrittlement (anode).

The present invention enables inexpensive and scalable manufacture of large-format bipolar plates.

FIG. 1 shows a top view of a bipolar plate 1. In particular, four bushing regions 4 are present close to each of the four corners of the preferably rectangular design of the bipolar plate 1.

Electrolyte is introduced and discharged in the bushing regions 4.

FIG. 2 shows a cross section according to FIG. 1, in which the bilayer structure of the bipolar plate 1 is shown in schematic form.

The bipolar plate 1 has an upper metal sheet 21 and lower metal sheet 22.

The thicknesses of the metal sheets 21, 22 are shown here merely schematically; in other words, the thicknesses of the metal sheets 21, 22 may be equal or, depending on which material for a metal sheet 21, 22 is more mechanically stable, may be different.

The sheet metal thicknesses are in the range of 0.1 mm-5 mm, preferably 0.5 mm.

Distinctly different materials are used for the metal sheets, i.e. the matrix is different, and so one metal sheet is based on iron (steel) or is a nickel base material and the other metal sheet is not, in particular in that it is based on titanium (Ti), niobium (Nb), tantalum (Ta) or zirconium (Zr),

or at least one alloy element is present to a greater or lesser degree,
or the proportion of one alloy elements differs by at least 10%, especially by at least 20%.

The following material combinations for upper metal sheet 21 and lower metal sheet 22 are possible:

For the cathodic side, a
stainless steel, especially an austenitic stainlesssteel, is used:
duplex: duplex is a steel having a two-colored microstructure, consisting of a ferrite matrix with islands of austenite and having more than 20% chromium (Cr), about 5% nickel (Ni) and 3% molybdenum (Mo),
superduplex: superduplex, compared to duplex, has a higher chromium (Cr) content, nickel (Ni) content and molybdenum (Mo) content,
hyperduplex: hyperduplex, compared to superduplex, again has slightly elevated chromium (Cr), nickel (Ni) or molybdenum values (Mo),
Nitronic 50: is a steel comprising chromium (Cr), nickel (Ni), manganese (Mn), molybdenum (Mo), silicon (Si), niobium (Nb), vanadium (V), and has been hardened by nitrogen (N).

It is likewise possible to use, rather than the steels, nickel base alloys:
Alloy C276: a nickel-chromium-molybdenum alloy comprising tungsten (W);
Incoloy: a nickel base alloy containing iron (Fe) and chromium (Cr), which may include additions of aluminum (Al), titanium (Ti), copper (Cu), manganese (Mn), cobalt (Co), silicon (Si), molybdenum (Mo) and/or niobium (Nb);
Inconel: a chromium-containing nickel base alloy comprising iron (Fe), molybdenum (Mo), niobium (Nb), cobalt (Co), manganese (Mn), copper (Cu), aluminum (Al), titanium (Ti), silicon (Si), sulfur (S), phosphorus (P) and boron (B);
nickel (Ni);
Nilo: Nilo is a steel comprising nickel (Ni) and small fractions of aluminum (Al), carbon (C), cobalt (Co), manganese (Mn), molybdenum (Mo), silicon (Si);
Nimonic: is a nickel base alloy comprising fractions of chromium (Cr), cobalt (Co), titanium (Ti) and aluminum (Al);
Nitronic: a chromium-nickel steel comprising fractions of manganese (Mn) inter alia, hardened by nitrogen (N);
Waspaloy: a nickel base alloy based on curing of an austenitic, face-centered cubic structure and includes, inter alia, chromium (Cr), molybdenum (Mo), cobalt (Co), aluminum (Al), titanium (Ti), carbon (C) and zirconium (Zr), and optionally also iron (Fe), manganese (Mn), silicon (Si), phosphorus (P), sulfur(S) and copper (Cu);
Invar: an iron-nickel alloy having a very low coefficient of expansion;
1.4404 steel: 1.4404 steel is a stainless, austenitic chromium-nickel-molybdenum steel having a low carbon (C) content. With high corrosion resistance as a result of addition of 2%-2.5% molybdenum (Mo);
1.4401 steel is a stainless austenitic chromium-nickel- molybdenum steel. It has good corrosion resistance as a result of addition of 2%-2.5% molybdenum (Mo).

For the anodic side,
titanium (Ti) or a titanium alloy,
niobium (Nb) or a niobium alloy,
zirconium (Zr) or a zirconium alloy,
tantalum (Ta) or a tantalum alloy is used.

In the case of titanium, preference is given to using grade 1 titanium, grade 2 titanium.

Grade 1 titanium and grade 2 titanium, according to standard ASTM 265B, are unalloyed titanium (Ti).

Grade 1 and grade 2 differ essentially by the permissible allowed contaminations of oxygen (O) (grade 1 max. 0.18% by weight, grade 2 max. 0.25% by weight) and iron (Fe) (grade 1 max. 0.20% by weight, grade 2 max. 0.30% by weight), and the resulting, quite different mechanical properties.

In addition, grade 1 titanium (Ti) and grade 2 titanium may have impurities of carbon (C) (max. 0.08% by weight), nitrogen (N) (max. 0.03% by weight), hydrogen (H) (max. 0.015% by weight) and further elements (max. 0.1% by weight).

Further coating of the surfaces of the metal sheets 21, 22 that come into contact with media is possible.

These are preferably coatings applied by thermal spraying (e. g. atmospheric plasma spraying (APS), vacuum plasma spraying (VPS), flame spraying, high-velocity flame spraying (HVOF)), or by chemical or physical vapor deposition (CVD and PVD).

This is effected especially with gold (Au), platinum (Pt), iridium (Ir) for improvement of electrical contact.

The bushing regions 4 of the bipolar place 1 must be sealed between the two metal sheets 21, 22.

For this purpose, it is preferably possible to use three methods:

The first method is shown in FIG. 3.

In this method, in the area of the bushing region 4, collar forming 25 and collar crimping 27 are effected, such that one metal sheet 21, for example, runs around and through the bushing region 4 and firmly adjoins the surface of the other metal sheet 22.

The second method is shown in FIG. 4, in which a compressed sealing lug 29 with a ring is used, which encompasses the bushing region 4 and then seals the bushing region 4 in the region of the upper and lower metal sheets via compression 31.

The third method is illustrated by the dashed lines 7, 11 in FIG. 1, in which the sealing compound is applied, where the sealing compounds used are especially known sealing compounds such as liquid FKM, liquid PFA or Loctite.

The bilayer bond of upper and lower metal sheets 22, 21 is especially enabled by clinching and the resultant clinch bond 30 (FIG. 5).

Clinch bonds are known from joining technology. The bond enables separate and media-tight bonding of the two metal sheets 21, 22.

The clinch bonds may be executed at the edge of the bipolar plate.

In addition, there is also the possibility of two-dimensional and regular arrangement over the entire area of the bipolar plate.

Further means of bonding two metal sheets are roll cladding and explosion cladding.

The present invention enables longer lifetimes of PEM electrolysis and enables an inexpensive alternative to VPS-coated stainless steel/titanium bipolar plates. The method makes use of clinch technology which is suitable for mass production.

It has high mechanical robustness in relation to the manufacturing and assembly process, and fault-tolerant behavior with respect to surface damage.

By virtue of a multilayer concept by clinch bonding as proposed here, it is possible to prevent anodic and cathodic corrosion by a suitable material combination.

1-12. (canceled)

13. A bipolar plate for electrolysis, the bipolar plate comprising:
metal sheets being a lower metal sheet and an upper metal sheet;
said metal sheets being bonded to one another; and
said metal sheets sheets being formed of materials that are distinctly different from one another, with “distinctly different” having the following meaning:
a matrix of the respective materials is different, with:
one of the metal sheets being based on iron (steel) or being a nickel based material and the other of the metal sheets not being based on iron (steel) or not being a nickel based material;
the other metal sheet being based on a metal selected from the group consisting of titanium (Ti), niobium (Nb), tantalum (Ta), and zirconium (Zr); or
at least one alloying element is present to a greater or lesser degree, or
a proportion of one alloying element differs between the metal sheets by at least 10%.

14. The bipolar plate according to claim 13, wherein the proportion of one alloy element differs by at least 20%.

15. The bipolar plate according to claim 13, wherein one material for one of said metal sheets includes stainless steel or a nickel based alloy.

16. The bipolar plate according to claim 15, wherein said stainless steel is austenite.

17. The bipolar plate according to claim 13, wherein the other material for the other metal sheet includes titanium (Ti), niobium (Nb), zirconium (Zr) or tantalum (Ta).

18. The bipolar plate according to claim 13, wherein the other material for the other metal sheet includes grade 1 or grade 2 titanium (Ti).

19. The bipolar plate according to claim 13, wherein the other material for the other metal sheet is an alloy selected from the group consisting of a titanium alloy, a tantalum alloy, a zirconium alloy, and a niobium alloy.

20. The bipolar plate according to claim 13, wherein the lower and upper metal sheets are of equal thickness.

21. The bipolar plate according to claim 13, wherein said lower and upper metal sheets are of different thickness, differing by at least 10%.

22. The bipolar plate according to claim 21, wherein a thickness of said lower metal sheet and a thickness of said upper metal sheet differ by at least 20%.

23. The bipolar plate according to claim 13, wherein said lower and upper metal sheets have a thickness of between 0.1 mm and 5.0 mm.

24. The bipolar plate according to claim 23, wherein said lower and upper metal sheets have a thickness of between 0.8 mm and 2.0 mm.

25. The bipolar plate according to claim 23, wherein said lower and upper metal sheets have a thickness of 0.5 mm.

26. The bipolar plate according to claim 13, wherein said lower and upper metal sheets are coated metal sheets having a coating selected from the group consisting of APS, VPS, HVOF, CVD, and PVD coatings.

27. The bipolar plate according to claim 13, wherein said lower and upper metal sheets are coated metal sheets having a coating containing at least one of gold (Au), platinum (Pt), or iridium (Ir) for improving electrical contact.

28. The bipolar plate according to claim 13, wherein the bipolar plate formed by said lower and upper metal sheets has bushing regions which are sealed:
by collar forming and collar crimping or
by way of a compressed sealing lug; or
by sealing compound.

29. The bipolar plate according to claim 13, wherein said lower and upper metal sheets are bonded to one another by a clinch bond.

30. The bipolar plate according to claim 13, wherein one material for one of the metal sheets comprises:
steel selected from the group consisting of:
stainless steel;
austenitic stainless steel;
duplex;
superduplex;
hyperduplex; and
nitronic 50; or
a nickel based alloy selected from the group consisting of:
alloy C276;
Incoloy®;
inconel;
nickel;
nilo;
nimonic;
nitronic;
waspaloy;
invar;
1.4404 steel; and
1.4401 steel.

31. The bipolar plate according to claim 30, wherein the one material for the one of the metal sheets comprises austenitic stainless steel.

32. A method for producing a bipolar plate according to claim 13, the method comprising:
firmly bonding the two metal sheets to one another by a process selected from the group consisting of clinch bonding, plating, and welding.
